(19) United States
(12) Patent Application Publication
(10) Pub. No.: US 2009/0294426 A1
(43) Pub. Date: Dec. 3, 2009

(54) SYSTEM AND METHOD FOR BEAM-TO-COLUMN WELDING

(76) Inventor: WILLIAM L. BONG, Walnut Creek, CA (US)

Correspondence Address: LAW OFFICES OF CHARLES L. THOEMING;BIELEN, LAMPE & THOEMING, P.A., TWO CORPORATE CENTRE 1390 WILLOW PASS ROAD, SUITE 1020, CONCORD, CA, 94520, US

(21) Appl. No.: 12/474,859

(22) Filed: May 29, 2009

Related U.S. Application Data
(60) Provisional application No. 61/058,506, filed on Jun. 3, 2008.

(51) Int. Cl. B23K 9/00

(52) U.S. Cl. 219/136

(57) ABSTRACT

A system and method for welding horizontal beams to vertical columns includes a holding assembly, at least four distributed control welding torches, track assemblies for three-dimensional positioning of the welding torches along the weld seam, back-up bars, run-off tabs and sumps affixed at the beam to column welds. Embodiments for single pass and multipass high deposition, submerged arc welds are disclosed.

### CROSS-REFERENCES TO RELATED APPLICATIONS

This United States non-provisional patent application is based upon and claims the filing date of U.S. provisional patent application Ser. No. 61/058,506 filed Jun. 3, 2008.

### STATEMENT REGARDING FEDERALLY SPONSORED RESEARCH OR DEVELOPMENT

None.

### REFERENCE TO A MICRO-FICHE APPENDIX

None.

### TECHNICAL FIELD

This invention relates to welding. More particularly, the invention is related to a system and method for beam-to-column welding.

### BACKGROUND OF THE INVENTION

My U.S. Pat. No. 6,297,472, issued Oct. 2, 2001 [the “'472 patent”], discloses and claims a welding system and method comprising a distributed welding control system that allows a welding operator to program automated welding cycles for various welding operations, and which is particularly useful for installing stiffener plates onto structural beams. In the '472 patent, the welding system comprises a welding fixture with a pair of opposing, positionally adjustable welding shoes, and lock screws for attaching a workpiece such as an I-beam. The welding is controlled by a computer-controlled, programmable, modular control system with modular mechanical components that allows the entire welding operation to be repeated perfectly each and every time. The system is also composed of standardized modular mechanical components. A rotary straight wire feeder removes the cant and helix from welding wire as it is fed to the welding torch, keeping the welding wire absolutely straight. Computer controlled, programmable automated welding requires that the welding wire remain absolutely straight so that perfect welds can be repeated every time—eliminating the need for a skilled operator to accomplish the task for every weld. Weld defects will result if the wire that comes out of the torch is not kept straight, and in the center of the weld cavity.

My U.S. Pat. No. 7,038,159, issued May 2, 2006 [the “159 patent”], discloses and claims a system and method for Electroslag butt welding expansion joint rails comprising a distributed welding control system. The welding operation is also is composed of a computer-controlled, programmable, modular control system with modular mechanical components that allows the entire welding operation to be repeated perfectly each and every time. A rotary straight wire feeder, or 3-wire counter bending wire straightener removes the cant and helix from welding wire as it is fed to the welding torch, keeping the welding wire absolutely straight. The system is also composed of standardized modular mechanical components. The method includes defining a weld cavity with a first expansion joint rail, a second expansion joint rail, a plurality of gland shoes, and a pair of buff shoes, and can be adapted for welding an expansion joint rail to a support beam. My pending U.S. patent application for a system and method of metal powder welding provides many of the welding system components useful to achieve embodiments of the system and method for beam-to-column welding.

The welding system and method for beam-to-column welding combines certain disclosed and claimed features of my patents described herein, and and/or their continuation or continuation-in-part progeny, to allow a welding operator to program automated welding cycles for various welding operations; and, as a result, these patent are particularly useful for embodiments beam-to-column welding systems and assemblies using high deposition, submerged arc welding.

### DISCLOSURE OF INVENTION

When erecting high-rise buildings (on site), horizontal beam flanges are welded to vertical column flanges by either (1) multipass “gasless flux-core wire welding process,” or (2) multipass “gas shielded flux-core wire welding process.” Either option presents a long and laborious process. To facilitate the speed of erecting a high-rise building, Arcmatic™ has devised a method of automating the welding process by making beam flange-to-column flanges much faster. The welding operation is also composed of a computer-controlled, programmable, modular control system with modular mechanical components that allows the entire welding operation to be repeated perfectly each and every time. A rotary straight wire feeder, or 3-wire counter bending wire straightener removes the cant and helix from welding wire as it is fed to the welding torch, keeping the welding wire absolutely straight. The system is also composed of standardized modular mechanical components.

The system and method for beam-to-column welding includes having the horizontal beam bolted to the vertical column flange. This bolted connection holds the beam in position and sets the gap for the high deposition, submerged arc (“HD-SubArc™”) welding operation until the welding is being has been completed. One-inch square copper backup bars are positioned below the upper and lower 30-45 degree beveled flange weld joints. Each copper bar has a chamfer on the inside corner. Prior to welding, the chamfer is filled with submerged arc welding flux. The submerged arc welding flux protects the back side of weld. The rest of the weld joint is filled with metal powder prior to welding.

An embodiment of the method and system includes high density submerged arc welding torches along the weld joint to make the single-pass, or a multipass weld. This embodiment for (HD-SubArc™) beam-to-column welding includes a clamp-on welding fixture that moves dual-wire high deposition (HD) submerged arc (SubArc™) welding torches along the weld joint to make the single-pass, or a multipass weld. A set of motorized slides are included on the right side and the left side of the top beam flange, and a set of motorized slides are included on the right side and the left side of the bottom beam flange. The motorized slides are clamped onto the respective and corresponding beam flanges.

These four sets of slides are used to carry and position the four twin-wire welding torches as they move down the weld seam. In order to build the weld puddle to the proper height, the right and left torches on the top flange and the right and left torch on the bottom flange simultaneously start the weld in the center of the weld cavity. Using a single torch to travel the full width of the weld joint can be used as an alternate method on the top flange. This is not possible with the bottom flange because of the beam flange in the center of the weld path. After the initial weld puddle height has been achieved, the torches move the welding puddle toward the outer edge of the beam width. Run-off tabs are placed on either side of the weld cavity to allow the welding puddle to travel beyond the flange width. Once the weld has been completed, the run-off tabs are cut off and ground flush with the corresponding workpiece surface.

The torch carrying devices are composed of a longitudinal motorized carriage that runs parallel to the weld seam, and an “in-and-out” motorized slide that positions the torch in its proper position with respect to the weld seam.

Other features, advantages, and objects of the system and method for Electroslag beam-to-column welding will become apparent with reference to the following description and accompanying drawings.

These together with other objects of the system and method for Electroslag beam-to-column welding, along with the various features of novelty that characterize the system or method, are described with particularity in the claims attached to and forming a part of this disclosure. For a better understanding of the system and method for beam-to-column welding, its operating advantages and the specific objects attained by its uses, reference should be made to the attached drawings and descriptive materials in which there are illustrated preferred embodiments of the system or method.

### BRIEF DESCRIPTION OF DRAWINGS

The above stated features, aspects, and advantages of the system and method for Electroslag beam-to-column welding will become better understood with regard to the following description, appended claims, and accompanying drawings as further described.

FIG. 1 is a side elevation view of a horizontal beam 200 welded to a vertical column 500.

FIG. 2 is a perspective detail view of J-groove bevel 211 weld joints 208 and 210 between a horizontal beam 200 and a vertical column 500.

FIG. 3 is a beam 200 end elevation view of the clamp-on welding fixture of an embodiment of the system and method for beam-to-column welding that moves the welding torches along the weld joint to make the single or multipass weld.

FIG. 4 is a side elevation view of an embodiment of the system and method for beam-to-column welding depicting two horizontal beams 200 (one on either side of the vertical column 500), both to be welded to the vertical column 500 flanges on either side of the moment connections 218 that have been welded between the two flanges of the vertical column 500.

FIG. 5 is a side elevation view of an embodiment of the system and method for beam-to-column welding depicting a horizontal beam 200 being welded to a vertical column 500 wherein the welding equipment makes the top and bottom beam-to-column flange welds by the Arcmatic™ high deposition, submerged arc welding (“HD-SubArc+MP™”) welding process.

FIG. 6 is a beam 200 end elevation view of an embodiment of the system and method for beam-to-column welding depicting dual sets of welding torch assemblies equipment making top and bottom beam-to-column welds for two flange-to-column welded connections by the Arcmatic™ HD SubArc+MP™ welding process.

FIG. 7A is a side detail view of an embodiment of the system and method for beam-to-column welding depicting a typical single-pass welding procedure for a 0.40 inch beam 200 thickness, with the chamfer filled with submerged arc welding flux to keep the backside of the weld from contamination.

FIG. 7B is a side detail view of an embodiment of the system and method for beam-to-column welding depicting a typical single-pass welding procedure for a 0.61 inch beam 200 thickness, with the chamfer filled with submerged arc welding flux to keep the backside of the weld from contamination.

FIG. 7C is a side detail view of an embodiment of the system and method for beam-to-column welding depicting a typical multi-pass welding procedure for a 0.81 inch beam 200 thickness, with the chamfer filled with submerged arc welding flux to keep the backside of the weld from contamination.

FIG. 8A is a side detail view of an embodiment of the system and method for beam-to-column welding depicting typical multi-pass welding procedures for a 1.01 inch beam 200 thicknesses, with the chamfer filled with submerged arc welding flux to keep the backside of the weld from contamination.

FIG. 8B is a side detail view of an embodiment of the system and method for beam-to-column welding depicting typical multi-pass welding procedures for a 1.22 inch beam 200 thicknesses, with the chamfer filled with submerged arc welding flux to keep the backside of the weld from contamination.

FIG. 8C is a side detail view of an embodiment of the system and method for beam-to-column welding depicting typical multi-pass welding procedures for a 1.42 inch beam 200 thicknesses, with the chamfer filled with submerged arc welding flux to keep the backside of the weld from contamination.

FIG. 9 is a system schematic of operator's control interface 800 including the operator's control panel 810 and liquid crystal display (LCD) 820, parallel input and output unit 830, display interface 840, microprocessor control unit 850, operator interface program 852, network interface program 854, system supervisor program 856, and network interface 860.

FIG. 10 is an isometric view of a representative operator's control panel 810 and LCD 820 of FIG. 9.

FIG. 11A is a partial flow diagram of the steps of a method for an embodiment of the system and method for beam-to-column welding.

FIG. 11B is the balance of the partial flow diagram of FIG. 11A of the steps of a method for an embodiment of the system and method for beam-to-column welding.

### BEST MODE FOR CARRYING OUT THE INVENTION

My following U.S. Letters Patent are incorporated by reference as if fully set forth herein: U.S. Pat. No. 6,297,472 for Welding System and Method, issued Oct. 2, 2001 (the “'472 patent”); U.S. Pat. No. 7,038,159 for Electroslag Butt-Welding Expansion Joint Rails, issued May 2, 2006 (the “'159 patent”); U.S. Pat. No. 7,148,443 for Consumable Guide Tube, issued Dec. 12, 2006 (the “'443 patent”); and U.S. Pat. No. 7,429,716 for Modular Welding System, issued Sep. 30, 2008 (the “'716 patent”).

My following pending U.S. non-provisional patent applications are incorporated by reference as if fully set forth herein: U.S. application Ser. No. 11/591,190 for Consumable Guide Tube, filed Oct. 30, 2006 (the “'190 application”); U.S. application Ser. No. 12/212,019 for System and Method of Electroslag Welding Spliced Vertical Columns, filed Sep. 17, 2008 (the “'019 application”) and U.S. application Ser. No. 12/352,297 for System and Method of Electroslag Welding Spliced Vertical Box Columns, filed Jan. 12, 2009 (the “'297 application”). Also my pending U.S. application for a System and Method for Metal Powder Welding Applications is incorporated by reference as if fully set forth herein.

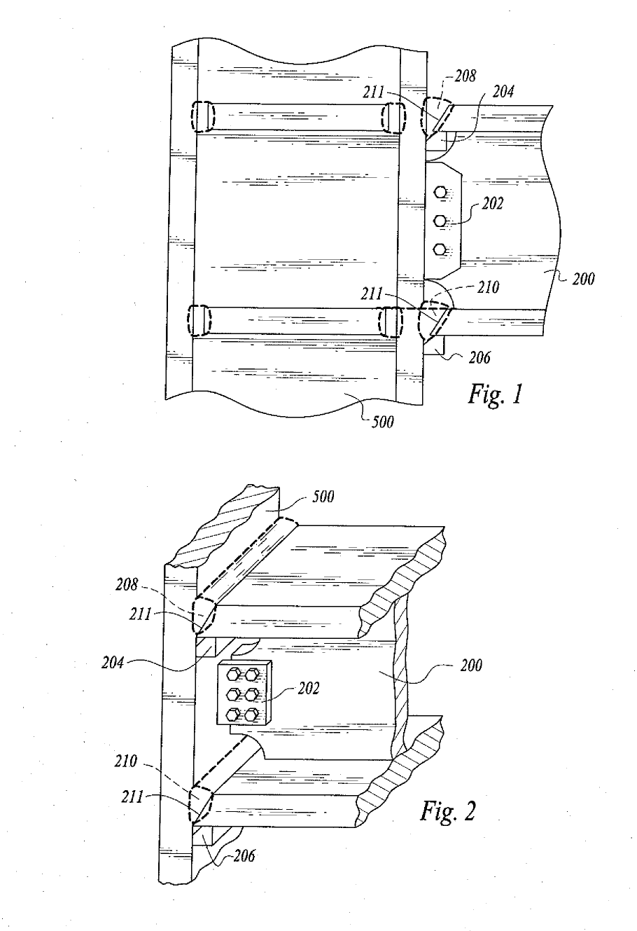

Referring more specifically to the drawings, for illustrative purposes the system and method for beam-to-column welding is embodied generally in FIGS. 1-11B. It will be appreciated that the system may vary as to configuration and as to the details of the parts, and that the method of using the system may vary as to details and to the order of steps, without departing from the basic concepts as disclosed herein. The system and method for welding are disclosed generally in terms of beam-to-column welding, as this particular type of welding operation is widely used. However, the disclosed system and method for the Arcmatic™ HD-SubArc™ beam-to-column welding may be used in a large variety of welding applications, as will be readily apparent to those skilled in the art.

The system and method for the Arcmatic™ HD-SubArc™ beam-to-column welding includes having the horizontal beam 200 bolted to the vertical column flange 500, FIG. 1. This bolted connection holds the horizontal beam 200 in position until the welding has been completed. One-inch square copper backup bars 204 and 206 are positioned below the upper and lower 30-to-45 degree bevel flange weld joints, 208 and 210 respectively. Each copper bar 204, 206 has an approximately ½ inch chamfer (the chamfer size depends on the thickness of the beam flange) on the inside corner. Prior to welding, this chamfer is filled with submerged arc welding flux. Filling the chamfer of the copper bar with submerged arc welding flux protects the backside of the molten weld puddle from oxidation. The rest of the weld joint is filled with metal powder prior to welding.

As depicted in FIG. 2, a “J-groove” bevel 211 is used for an embodiment of the method and system of the Arcmatic™ HD-SubArc™ beam-to-column welding in place of the 30 degree beveled weld joint. The “J-groove bevel 211 weld joint is much easier to fill (in a single pass) because the J-groove has a much narrower width at the top of the weld joint.

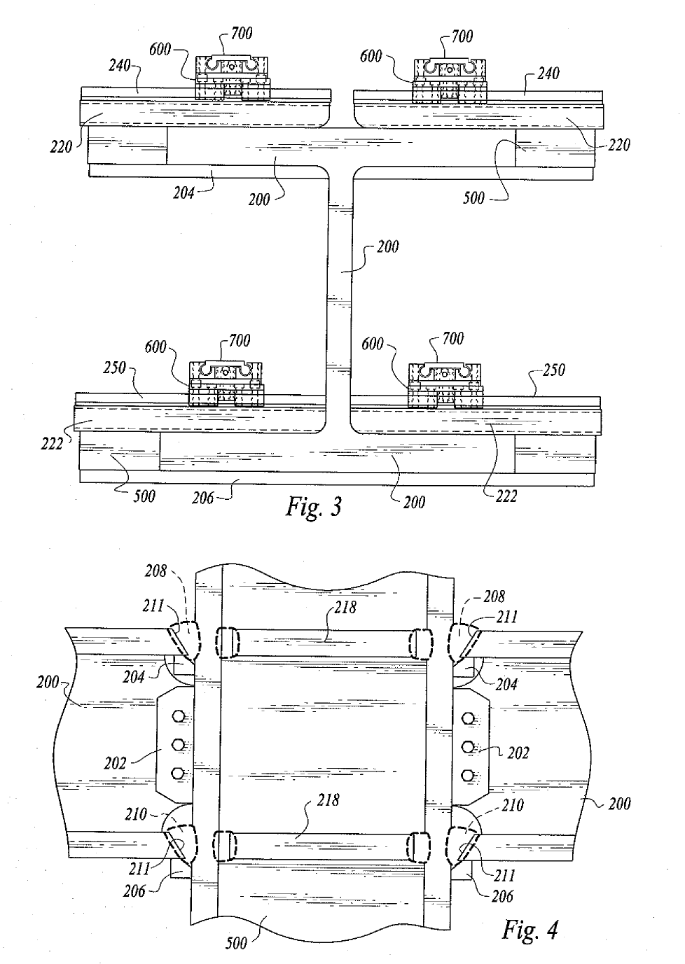

An embodiment of the method and system of the Arcmatic™ HD-SubArc™ beam-to-column welding, FIG. 3, includes a clamp-on welding fixture—consisting of a right/left motorized carriage with an in/out motorized torch positioning slide 600 that moves the welding torches along the weld joint (not shown in this view). The right and left mechanism that clamps to the upper part of the flange 220, 230 are used to mount the slide tracks so that the entire mechanism can quickly clamp the welding torches and track assemblies into position to make the single-pass weld, FIG. 3. A set of motorized slide tracks 240 are provided on the right side and the left side of the clamping mechanism of the top beam flange 200, and a set of motorized slide tracks 250 are provided on the right side and the left side of the bottom beam flange 200.

These four sets of tracks 240, 250 are used to carry and position the four motorized weld travel carriage assembly 600 slides and weld torch 700 slides as they move down the travel tracks 240, 250. In order to build the weld puddle to the proper height, the right and left torches on the top flange and the right and left torch on the bottom flange simultaneously start the weld in the center of the weld cavity. After the initial weld puddle height has been achieved, the torches move toward outer edge of the beam width. Run-off tabs are placed on either side of the weld cavity to allow the torch to travel beyond the flange width. After the weld has been completed, the run-off tabs are cut off and ground flush with the corresponding workpiece surface.

The torch carrying devices are composed of a longitudinal motorized weld travel carriage assembly 600 that runs parallel to the weld seam, and an “in-and-out” motorized slide and weld torch 700 that positions the torch in its proper position with respect to the weld seam.

A moment connection 218 with horizontal beams 200 to be welded to either side is depicted in FIG. 4. This is a typical setup for connecting the horizontal beam 200 to the vertical column 500. In the shop, a side plate 202 is welded to the side of the vertical column 500 with bolt holes drilled into the plate, and moment connections 218 are welded between the two flanges of the vertical column 500. In the field, when the horizontal beam 200 is lowered into position, the holes in the end of the horizontal beam 200 are aligned with the holes in the side plate 202 that has been welded onto the vertical column 500. Bolts are used to quickly connect the horizontal beam 200 to the column 500. This operation automatically aligns the horizontal beam flange weld joints 208, 210 to the vertical column 500. The connection is not complete until the upper and lower beam flanges 200 are welded to the vertical column flange 500.

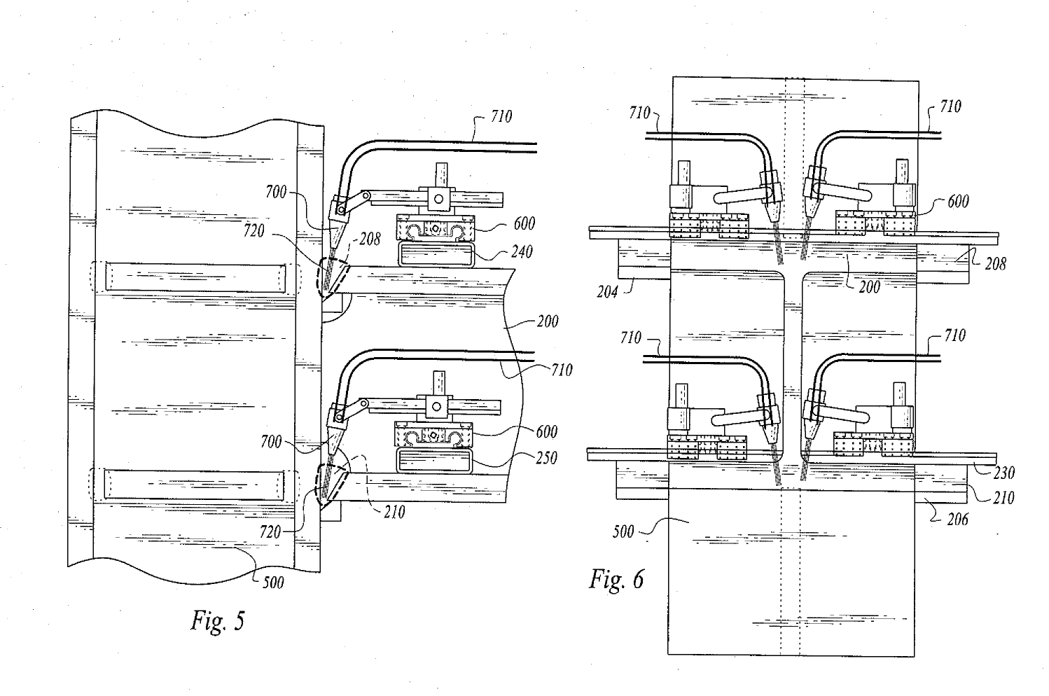

Dual two-wire Arcmatic™ HD-SubArc™ welding apparatus 700 are shown positioned in a side detail elevation view of the vertical column flange 500 and horizontal beam flange 200, FIG. 5. The welding equipment illustration depicts a weld being made on the top 208 and bottom 210 beam-to-column flange welds 208, 210 by the Arcmatic™ HD-SubArc™ welding process. The bottom of the horizontal travel carriage is illustrated as a piece of tubing 240, 250. This tubing 240, 250 is clamped to either side of the width of the horizontal beam flange 200. The motor driven carriage 600 is driven back and forth across the width of the beam flange, carrying the motorized in/out torch slide mechanism that holds the HD-SubArc™ Two-wire welding torch. Two is 1/16 inch, 3/32 inch, or ⅛ inch diameter wires (or any other applicably sized diameter wires) are fed from the wire feeder, through wire feed conduits, to the two-wire welding torches.

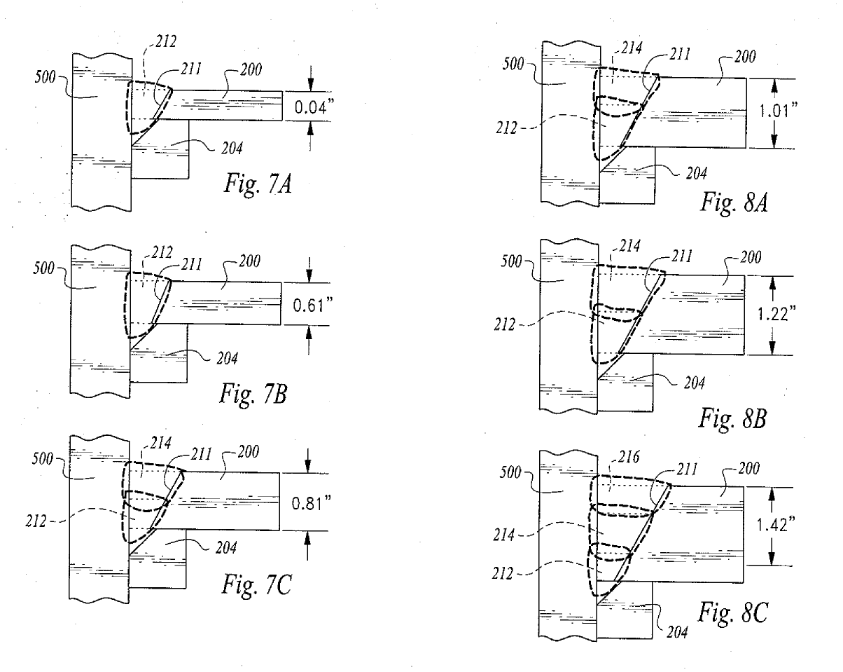

High current welding cables and wire feed conduits 710 from the welding power supply(s) are attached to the high current, two-wire welding torch 700. The two welding wires are depicted in 720. The welding joint 208, 210 is filled with the proper amount of arc welding flux on top of metal powder (212, 214, 216) to make a successful welding pass. One, two, three, or more weld passes, depending upon the beam 200 thickness, are used to fill the welding joint 208, 210, FIGS. 7A-8C. An embodiment of the beam-to-column welding system includes a single pass weld using metal powder and a high current, two-wire torch, FIGS. 7A and 7B. Multiple passes may require the slide on top of the torch carriage 600 to oscillate to spread the weld to eliminate incomplete penetration on the wet lines, FIGS. 7C-8C.

When the welding wire is feed through the welding torch contact tip, into the weld joint, the welding wire strikes an arc against the metal powder. The high current, two wire welding torch 700 allows very high welding current to melt the metal powder beneath the welding flux (212, 214, 216). The metal powder, in turn melts the base material on either side of the weld joint. This high current process allows the weld to be made in fewer passes, with lower input. Because the metal powder beneath the welding flux (212, 214, 216) absorbs between 40 percent and 50 percent of the total heat input, the system and method for the Arcmatic™ HD-SubArc™ beam-to-column welding more than doubles the amount of weld metal that could be generated by the welding wire alone. Since the metal powder absorbs such a large percentage of the arc energy, and more than doubles the deposition rate, far less heat input goes into the parent material as Heat Affected Zone (HAZ). Accordingly, beam flange thicknesses from ⅜ inch to 1½ inches typically can be made in a single pass, FIGS. 7A and 7B.

From an end elevation view (looking through the horizontal beam to the column flange in the rear), FIGS. 5 and 6, an embodiment of the method and system the Arcmatic™ HD-SubArc™ beam-to-column welding includes using two torches 700 to make the weld. The torch 700 on the right will strike an arc in the center of the weld joint, at the same time that the torch 700 on the left will strike an arc. After the puddle is formed, the right torch 700 will move toward the outer edge of the right side of the beam width, while the left torch 700 will move toward the outer edge of the left side of the beam width. Both weld puddles will continue on to “run-off-tabs” and dwell before the weld cycle ends. After the weld has been completed, the operator cuts off the run-off tabs with a cutting torch, and the run-off tab surface is ground flush with the workpiece. An alternate embodiment includes a single two-wire welding torch 700 on the top flange to run the weld from the right width of the welding joint to the left width.

Typical multi-pass welding procedures for varying horizontal beam thicknesses are depicted in FIGS. 7C-8C. The underside of the weld uses a chamfered copper block 204. The chamfer is filled with welding flux to keep the backside of the weld from contamination. A predetermined depth of welding flux is poured on top of the submerged arc metal powder, (212, 214, 216), depending on a predetermined welding procedure. One or more weld passes are used to fill the welding joint, depending on the thickness of the beam flange, FIGS. 7A-8C. However, in many cases, this can be done in one single pass, FIGS. 7A and 7B.

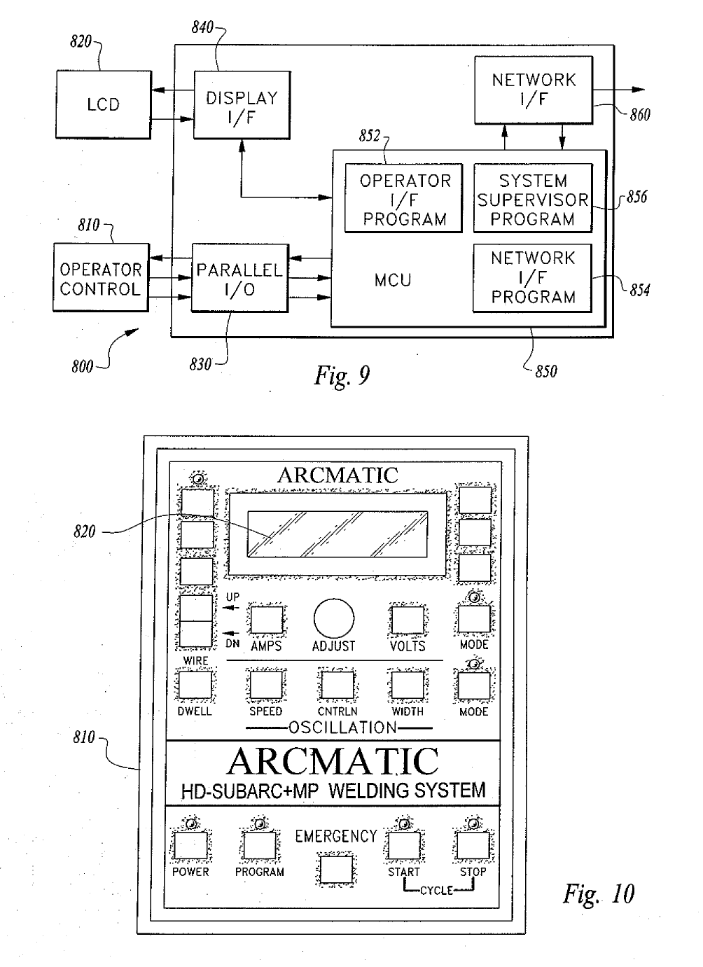

The welding process and the welding procedures for the embodiments of the method and system of the Arcmatic™ HD-SubArcm™ beam-to-column welding can be pre-programmed into the Arcmatic™ programmable, computer controlled integrated welding system, FIGS. 9-11B. The Arcmatic™ distributed welding control system 800 provides fully automatic control over the Arcmatic™ HD-SubArc™ beam-to-column welding process from the operator's interface control panel 810. The Arcmatic™ HD-SubArc™ beam-to-column welding includes a single pendant controller that provides overall system control for a number of discreet motion control networks including microprocessor modular distributed control of each welding torch, each welding torch slide assembly, each in and out assembly, each wire feed conduit, each high current welding cable, welding power supply, and each weld within each welding cavity through a system supervisor program 856, network interface program 854, and an operator interface program 852 of a microprocessor control unit 850. An embodiment of the beam-to-column Electroslag welding system includes a programmable welding fixture that clamps onto the horizontal beam.

Manual mode allows the operator to control the length of time for progam and final conditions Automatic mode provides timer based control of the beam-to-column welding system and method from when the “Cycle Start” button is pressed by the operator. Certain fault conditions terminate or prevent a welding cycle. The operator can switch from manual to automatic mode at any time during a welding cycle. The operator also has override control over any welding variable during the welding operation.

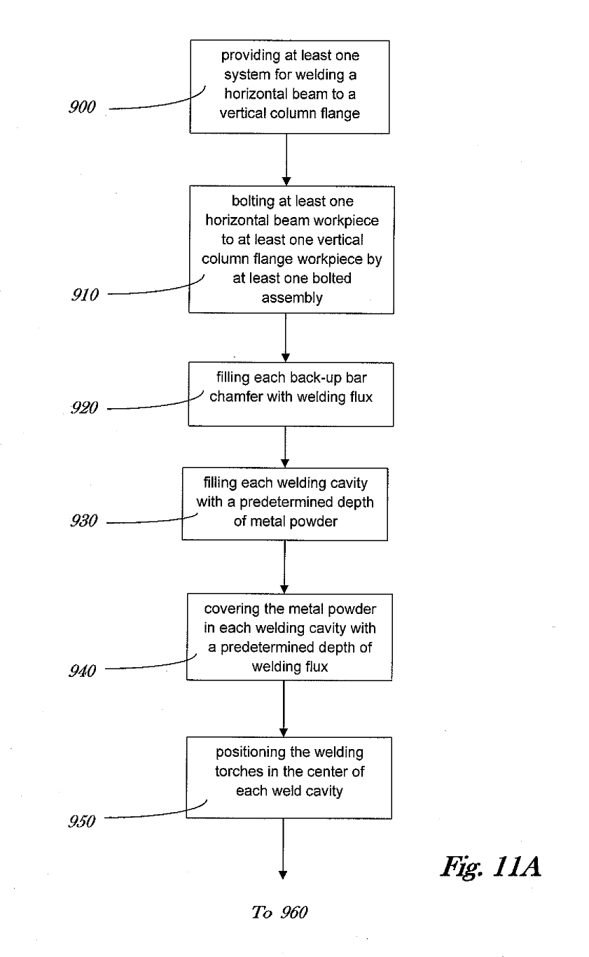

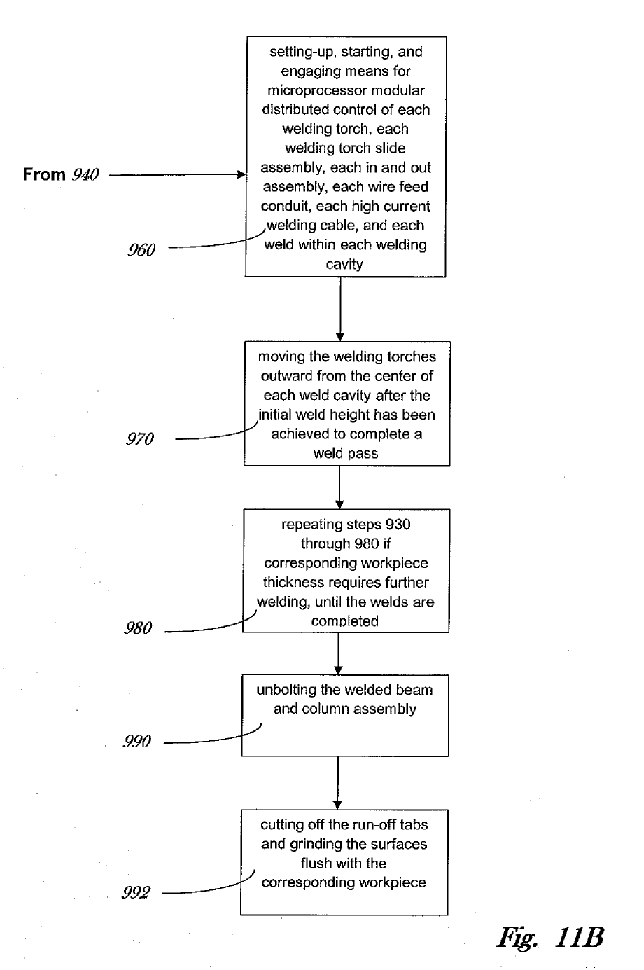

The operator interface panel 810, FIG. 10, provides overall control of the system, including set up and manual control of the of each welding torch, each welding torch slide assembly, each in and out assembly, each wire feed conduit, each high current welding cable, welding power supply, and each weld within each welding cavity. The operator interface also provides feedback to the operator and any errors that occur during the welding process. The system and method for beam-to-column welding is completely automatic once setup is complete.

The operator interface panel 810, FIG. 10, also includes switches to select various welding and system functions, mechanical encoders to set item values, control and position data from the LCD, and data packets returned by other system controller modules. Outputs include status indicator light emitting diodes (“LEDs”), the LED display panel, and data packets sent to other system controller modules. The operator interface panel 810 includes, and functions as, three separate programs—an operator interface program, a system supervisor program, and the network interface program—that passing data between and among themselves.

With reference to FIGS. 11A and 11B, an embodiment of the method for Arcmatic™ HD-SubArc™ beam-to-column welding includes the following steps:
a) providing at least one system for welding a horizontal beam to a vertical column flange according to claim 17;
b) bolting at least one horizontal beam workpiece to at least one vertical column flange workpiece by at least one bolted assembly;
c) filling each back-up bar chamfer with welding flux;
d) filling each welding cavity with a predetermined depth of metal powder;
e) covering the metal powder in each welding cavity with a predetermined depth of welding flux;
f) positioning the welding torches in the center of each weld cavity;
g) setting-up? starting, and engaging means for microprocessor modular distributed control of each welding torch, each welding torch slide assembly, each in and out assembly, each wire feed conduit, each high current welding cable, and each weld within each welding cavity;
h) moving the welding torches outward from the center of each weld cavity after the initial weld height has been achieved to complete a weld pass;
i) repeating steps d) through g) if corresponding workpiece thickness requires further welding, until the welds are completed;
i) unbolting the welded beam and column assembly; and
k) cutting off the run-off tabs and grinding the surfaces flush with the corresponding workpiece when the weld has been completed.

Accordingly, the welding operator for any disclosed method and system of the Arcmatic™ HD-SubArc™ beam-to-column welding; the operator principally needs to be a skilled operator capable of setting up the weld and running the pre-qualified welding programs. The same welding control system and methods used for Arcmatic™ VertaSlag™ welds of the '019 application and/or the '297 application, and/or the '472 patent, the '716 patent, and/or the '159 patent, are used to operate and control the method and system of the Arcmatic™ HD-SubArC™ beam-to-column welding including, but not limited to, automating the beam-to-column flange welds “on the job” in the field.

I claim:

1. A system for welding a beam to a vertical column flange, the system comprising in combination:
a) means for releasably attaching at least one horizontal beam workpiece to a vertical column flange so that the horizontal beam and vertical column flange are positioned in a desired alignment for welding the horizontal beam to the vertical column flange defining at least two longitudinal welding cavities between the horizontal beam and vertical column flange, each welding cavity suitable for welding within the cavity;
b) means for providing upper and lower weld joint positions between each horizontal beam workpiece and each vertical flange;
c) means for three dimensional movement of at least one welding torch at each weld joint position and for welding power supply;
d) high current welding cables for each welding torch;
g) wire feed conduits for each welding torch; and
h) means for microprocessor modular distributed control of each welding torch, each means for three dimensional movement of each welding torch, each wire feed conduit, each high current welding cable, each welding power supply, and each weld within each welding cavity.

2. The system for welding a beam to a vertical column flange of claim 1, wherein means for providing upper and lower weld joint positions between each horizontal beam workpiece and each vertical flange comprises at least two back-up bars positioned at the welding cavities providing upper and lower weld joint positions between each horizontal beam workpiece and each vertical flange, each back-up bar comprising a uniform chamfer sized to correspond to the horizontal beam thickness.

3. The system for welding a beam to a vertical column flange of claim 1, wherein means for three dimensional movement of at least one welding torch at each weld joint position comprises at least four motorized welding torch slide assemblies for each horizontal column to vertical column flange weld, each assembly comprising a longitudinal motorized carriage and positioning slide and motorized slide tracks to move the weld torch along the corresponding weld joint position and at least one welding power supply, whereby a pair of motorized welding torch slide assemblies are positioned on the top of the horizontal flange weld joint position and a pair of motorized welding torch slide are positioned on the bottom of the horizontal beam flange weld joint position.

4. The system for welding a beam to a vertical column flange of claim 1, wherein means for three dimensional movement of at least one welding torch at each weld joint position comprises at least four motorized welding torch in and out assemblies for each horizontal column to vertical column flange weld joint position, each assembly comprising a motorized carriage to move the weld torch in proper position with respect to a weld seam within the weld joint position.

5. The system for welding a beam to a vertical column flange of claim 3, wherein each welding torch comprises high current, dual welding wire assemblies.

6. The system for welding a beam to a vertical column flange of claim 4, wherein each welding torch comprises high current, dual welding wire assemblies.

7. The system for welding a beam to a vertical column flange of claim 2, further comprising metal powder in each welding cavity.

8. The system for welding a beam to a vertical column flange of claim 7, further comprising a predetermined depth of welding flux poured on top of metal powder.

9. The system for welding a beam to a vertical column flange of claim 8, further comprising welding flux in the chamfer.

10. The system for welding a beam to a vertical column flange of claim 9, wherein the chamfer is copper.

11. A system for welding a beam to a vertical column flange, the system comprising in combination:
a) means for releasably attaching at least one horizontal beam workpiece to a vertical column flange so that the horizontal beam and vertical column flange are positioned in a desired alignment for welding the beam to the vertical column flange defining at least two welding cavities between the horizontal beam and vertical column flange, each such welding cavity defining a weld joint position;
b) at least two back-up bars positioned at the welding cavities providing upper and lower weld joint positions between each horizontal beam workpiece and each vertical flange, each back-up bar comprising a uniform chamfer sized to correspond to the horizontal beam thickness;
c) at least two uniform “J” groove bevels in the horizontal beam at the weld joint position between each horizontal beam workpiece and each vertical flange;
d) at least four motorized welding torch slide assemblies for each horizontal column to vertical column flange weld, each assembly comprising a longitudinal motorized carriage and positioning slide and motorized slide tracks to move the weld torch along the corresponding weld joint position, whereby a pair of motorized welding torch slide assemblies are positioned on the top of the horizontal flange weld joint position and a pair of motorized welding torch slide are positioned on the bottom of the horizontal beam flange weld joint position;
e) at least four motorized welding torch in and out assemblies for each horizontal column to vertical column flange weld joint position, each assembly comprising a motorized carriage to move the weld torch in proper position with respect to an Electroslag weld seam within the weld joint position and at least one power supply;
f) high current welding cables for each motorized welding torch;
g) wire feed conduits for each motorized welding torch; and
h) means for microprocessor modular distributed control of each welding torch and welding power supply, each welding torch slide assembly, each in and out assembly, each wire feed conduit, each high current welding cable, and each weld within each welding cavity.

12. The system for welding a beam to a vertical column flange of claim 11, wherein means for releasably attaching at least one horizontal beam workpiece to a vertical column flange comprises at least one bolted assembly.

13. The system for welding a beam to a vertical column flange of claim 12, further comprising a run-off tab on either side of each welding cavity.

14. The system for welding a beam to a vertical column flange of claim 13, wherein each back-up bar is copper and has a uniform one inch square cross-section before the uniform chamfer is cut.

15. The system for welding a beam to a vertical column flange of claim 14, further comprising arc welding flux filling each back-up bar chamfer.

16. The system for welding a beam to a vertical column flange of claim 15, further comprising a predetermined depth of metal powder in each welding cavity.

17. The system for welding a beam to a vertical column flange of claim 16, further comprising a predetermined depth of welding flux poured on top of the metal powder in each welding cavity.

18. A method for welding a horizontal beam to a vertical column flange, the method comprising the steps:
a) providing at least one system for welding a horizontal beam to a vertical column flange according to claim 17;
b) bolting at least one horizontal beam workpiece to at least one vertical column flange workpiece by at least one bolted assembly;
c) filling each back-up bar chamfer with welding flux;
d) filling each welding cavity with a predetermined depth of metal powder;
e) covering the metal powder in each welding cavity with a predetermined depth of welding flux;
f) positioning the welding torches in the center of each weld cavity;
g) setting-up, starting, and engaging means for microprocessor modular distributed control of each welding torch, each welding torch slide assembly, each in and out assembly, each wire feed conduit, each high current welding cable, and each weld within each welding cavity;
h) moving the welding torches outward from the center of each weld cavity after the initial weld height has been achieved to complete a weld pass;
i) repeating steps d) through g) if corresponding workpiece thickness requires further welding, until the welds are completed;
j) unbolting the welded beam and column assembly; and
k) cutting off the run-off tabs and grinding the surfaces flush with the corresponding workpiece when the weld has been completed.
